(19) United States
(12) Patent Application Publication
(10) Pub. No.: US 2017/0109156 A1
(43) Pub. Date: Apr. 20, 2017

(54) SYSTEM INCLUDING SOFTWARE AND NON-STOP UPGRADING METHOD OF RUNNING SOFTWARE

(71) Applicant: ELECTRONICS AND TELECOMMUNICATIONS RESEARCH INSTITUTE, Daejeon (KR)

(72) Inventors: Seung Woo HONG, Daejeon (KR); Ho Sun YOON, Daejeon (KR); Ho Yong RYU, Daejeon (KR)

(21) Appl. No.: 15/163,875

(22) Filed: May 25, 2016

(30) Foreign Application Priority Data
Oct. 20, 2015 (KR) 10-2015-0146204

(51) Int. Cl. G06F 9/445

(52) U.S. Cl. CPC G06F 8/67; G06F 8/66

(57) ABSTRACT

A system including software enables the running software to he upgraded without stopping any service. A system including software includes a task block loaded into a memory the task block being communicable with the outside through a message, and a dynamic module block loaded into the memory, the dynamic module block being symbolically linked with the task block to provide a service corresponding to the message.

### CROSS-REFERENCE TO RELATED APPLICATION

This application claims priority to and the benefit of Korean Patent Application No. 10-2015-0146204, filed on Oct. 20, 2015, in the Korean Intellectual Property Office, the entire contents of which are incorporated herein by reference in their entirety.

### BACKGROUND

1. Field

An aspect of the present disclosure relates to a system including software, which enables the running software to be upgraded without stopping any service, and a non-stop upgrading method of running software.

2. Description of the Related Art

A mission critical system refers to a system that has considerable social and economic influence if the system is shut down even only once, such as an Internet system, a telephone system, a banking system, or a transportation system. (e.g., a railway system, an airplane system, etc.).

The mission critical system is essentially provided with a high availability (HA) function such that trouble occurs in the system as little as possible. Also, the mission critical system provides a function of although trouble occurs, immediately recovering the trouble in a state in which a service is continuously maintained.

The HA of a system is expressed as a ratio of service occurrence time to service time. Ideally, the HA of the system should reach 100%, but it is likely that trouble will occur in any solid system.

The factor hindering the continuity of a service is generally divided into a planned downtime and an unplanned downtime. The planned downtime includes modification of a system, introduction of a new system, backup of data, modification of software, and the like. The unplanned downtime is trouble occurring in a service system, and the time required to recover the trouble is changed depending on a kind and degree of trouble.

Meanwhile, a method for duplexity a system is used to eliminate a downtime caused by modification of software during the planned downtime. In order to duplex a system, the system includes first and second system that provide the same service. The first and second systems alternately repeat operating and idle states.

For example, the first system may be set to the operating state, and the second system may be set to the idle state. In addition, when software is to be modified due to an error of the software or addition of a function during operation of a service, the software is modified using the following procedure.

First, software of the second system in the idle state is upgraded. Then, data operated in the first system, is synchronized with the software of the second system. In this case, the synchronization method may be variously set.

After the data is synchronized, the second system is set to the operating state, and provides a required service. In addition, the first system is set to the idle state, and upgrades software in the idle state.

Meanwhile, a system should he duplexed so as to upgrade software as described above. Further, it is not easy to synchronize software between two systems obtained by duplexity the system, and therefore, the complexity of the software is increased. Accordingly, it is required to develop a method for upgrading software without stopping any service in one system.

### SUMMARY

Embodiments provide a system including software, which enables the running software to be upgraded without stopping any service, and a non-stop upgrading method of running software.

According to an aspect of the present disclosure, there is provided a system including software, including: a task block loaded into a memory, the task block being communicable with the outside through a message; and a dynamic module block loaded into the memory, the dynamic module block being symbolically linked with the task block to provide a service corresponding to the message.

The dynamic module block may be replaceable without stopping the task block.

The task block may include: a task manager block including a message queue in which the message is stored; and a dynamic module manager block including a dynamic module interface reference for calling a function corresponding to the message and dynamic module data modified and generated corresponding to the service of the dynamic module block.

The dynamic module block may include: a service module block including service functions to provide the service; and a dynamic module wrapper block including a dynamic module interface having the service functions registered therein, the dynamic module interface being Symbolically linked with the dynamic module interface reference, and a dynamic module data reference symbolically linked with the dynamic module data.

According to an aspect of the present disclosure, there is provided a non-stop upgrading method of software including a task block and a first dynamic module block, the non-stop upgrading method including: storing, in a hard disk, a second dynamic module block for upgrading the first dynamic module block; requesting the task block to upgrade the first dynamic module block; unloading, by the task block, the first dynamic module block from a memory; loading, by the task block, the second dynamic module block into the memory; and connecting the second dynamic module block to the task block.

The connecting of the second dynamic module block may include: symbolically linking a dynamic module interface to a dynamic module interface reference included in the task block, wherein the dynamic module interface is included in the second dynamic module block and has function registered therein; and symbolically linking dynamic module data stored in the task block to a dynamic module data reference included in the second dynamic module block.

The connecting of the second dynamic module block may further include perfuming, by a service module block included in the second dynamic module block, a predetermined service using the dynamic module data.

The dynamic module data may be updated corresponding to the service of the service module block.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements ma also be present. Like reference numerals refer to like elements throughout.

FIG. 1 is a diagram illustrating a structure of a process of software according to an embodiment of the present disclosure.

FIG. 2 is a diagram illustrating a connection structure of a dynamic module manager block and a dynamic module wrapper block, shown in FIG. 1.

FIG. 3 is a diagram illustrating an initial execution procedure of the process of the software according to an embodiment of the present disclosure.

FIG. 4 is a diagram illustrating a message processing procedure of the process of the software according to an embodiment of the present disclosure,

FIG. 5 is a diagram illustrating an upgrading method of the software.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Throughout the drawings, like elements are designated by like reference numerals.

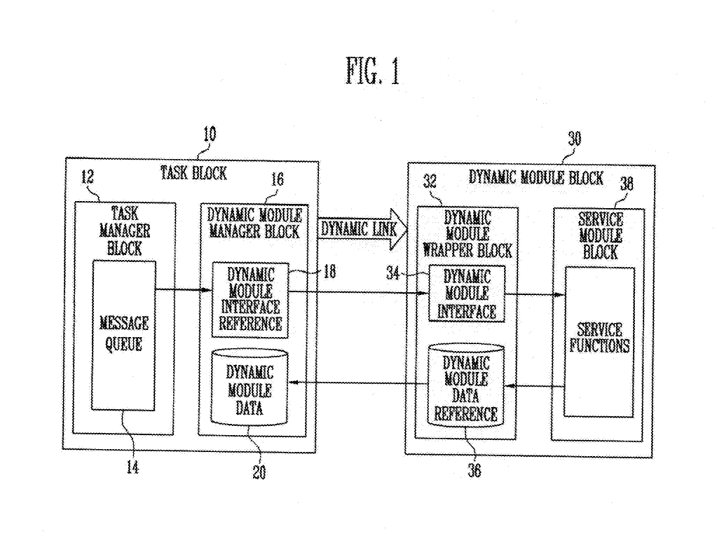

FIG. 1 is a diagram illustrating a structure of a process of software according to an embodiment of the present disclosure. The software of the present disclosure is installed in a system that provides a predetermined service. The software is operated as a process in an operating system (OS) such as Linux, Unix, or Windows. Communication between processes is performed using a message-based communication scheme such as a socket or a message queue, which is provided in the OS (as an embodiment, a message queue is illustrated in FIG. 1). In the process of the software according to the embodiment of the present disclosure, the running software can be upgraded without stopping an service due to the structure of the process of the software, and the process of the software has no influence on another process under communication even when the upgrading of the software is performed.

Referring to FIG. 1, the process of the software according to the embodiment of the present disclosure is configured with a task block 10 and a dynamic module block 30.

The task block 10 resides as a process in a memory when the software is run. The task block 10 is driven while residing in the memory until the process is ended. The task block 10 includes a task manager Nock 12 and a dynamic module manager block 16.

The task manager block 12 manages message communication of the process with another process to this end, the task manger block 12 includes a message queue 14. The message queue 14 ^{stores} request messages from the outside, and controls the stored request messages to be sequentially processed.

The dynamic module manager block 16 manages a connection between the task block 10 and the dynamic module block 30. To this end, the dynamic module manager block 16 includes a dynamic module interface reference 18 and dynamic module data 20.

The dynamic module interface reference 18 controls the dynamic module block 30 to perform a predetermined service, corresponding to a request message from the message queue 14. The dynamic module data 20 is data generated and/or modified corresponding to a service provided from the dynamic module block 30. The dynamic module data 20 is stored in the dynamic module manager block 16.

The dynamic module block 30 is a block in which major service functions are implemented when the process is executed. To this end, the dynamic module block 30 includes a dynamic module wrapper block 32 and a service module block 38.

The dynamic module wrapper block 32 is linked with the dynamic module interface reference 18, and allows a predetermined service to be provided from the service module block 38. To this end, the dynamic module wrapper block 32 includes a dynamic module interface 34 and a dynamic module data reference 36.

The dynamic module interface 34 is symbolically linked with the dynamic module interface reference 18.

The dynamic module data reference 36 is symbolically linked with the dynamic module data 20, and allows data generated and/or modified from the service module block 38 to be stored as the dynamic module data 20.

The service module block 38 includes service functions for providing services, and performs all functional services of the process.

Additionally, the dynamic module block 30 in which the major service functions are implemented may be upgraded (or replaced) as occasion when the process is executed. At this time, the task block 10 maintains an execution state and accordingly has no influence on another process with which the upgraded dynamic module block 30 communicates.

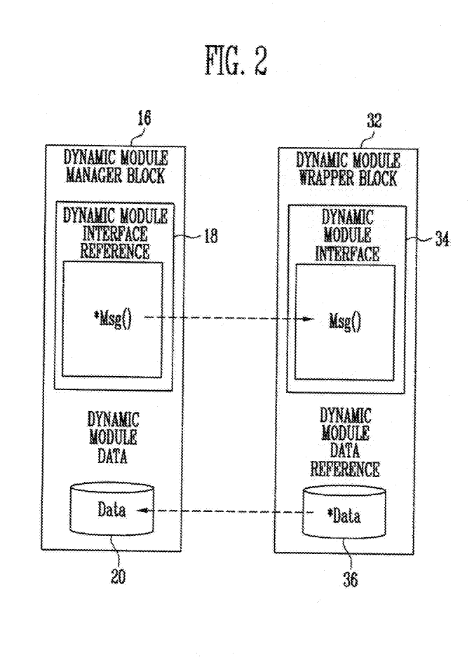

FIG. 2 is a diagram illustrating a connection structure of the dynamic module manager block and the dynamic module wrapper block, shown in FIG. 1.

Referring to FIG. 2, functions Msg( ) are registered in the dynamic module interface 34 included in the dynamic module wrapper block 32. For example, service functions stored in the service module block 38 may be sorted corresponding to a predetermined reference to be registered in the dynamic module interface 34.

The dynamic module interface reference 18 directly refers to the dynamic module interface 34. In this case, the dynamic module interface reference 18 may refer to (*Msg( )) service functions Msg( ) (*Msg( )→Msg( )). In other words, the dynamic module interface reference 18 is linked with the dynamic module interface 34, and therefore may call service functions such that a predetermined service is performed.

The dynamic module data Data (20) included in the dynamic module manager block 16 refers to data generated or modified corresponding to a service operation of the service module block 38. That is, in the present disclosure, the data generated by the service module block 38 is stored in the dynamic module manager block 16 that maintains a load state regardless of the upgrading of the software.

The dynamic module data reference *Data (36) directly refers to the dynamic module data 20 (i.e., *Data→Data). That is, the dynamic module data reference 36 is linked with the dynamic module data 20. Thus, when the dynamic module data reference 36 is controlled in the service module block 38, the dynamic module data 20 can be modified.

Meanwhile, if a cross reference between the dynamic module interface reference 18 and the dynamic module interface 34 and a cross reference between the dynamic module data reference 36 and the dynamic module data 20 are reset when the dynamic module block 30 is upgraded as occasion, the task block 10 and the upgraded dynamic module block 30 can be stably connected to each other. Further, although the dynamic module block 30 is upgraded and/or replaced, the dynamic module data 20 can be used as it is and thus the system can provide a service without stopping the process.

That is, the process of the software according to the present disclosure includes the task block 10 and the dynamic module block 30, and can correct and/or replace only the dynamic module block 30 without ending the process. That is, in the present disclosure, software can be upgraded without stopping any service in one system.

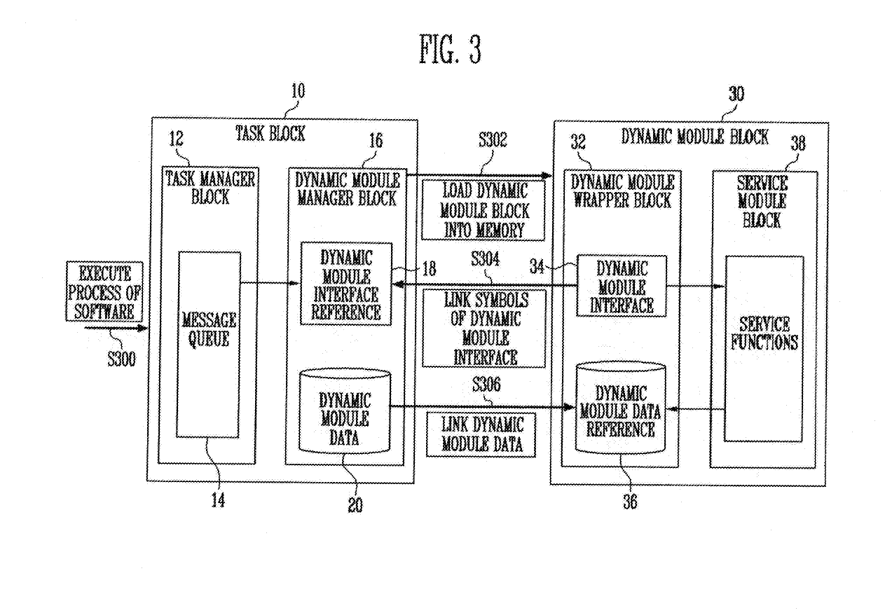

FIG. 3 is a diagram illustrating an initial execution procedure of the process of the software according to an embodiment of the present disclosure.

The initial execution procedure will be described as follows with reference to FIG. 3.

### <Executing of Software: S300>

First, the software is executed by a user, etc. If the software is executed, the task block 10 is loaded in the form of a process into the memory of the system.

### <Loading of Dynamic Module Block: S302>

After the task block 10 is loaded in the memory, the dynamic module manager block 16 loads the dynamic module block 30 implemented in the form of a dynamic library into the memory.

### <Linking of Symbols: S304>

After the dynamic module block 30 is loaded into the memory, the dynamic module manager block 16 links symbols of the service functions Msg( ) included in the dynamic module interface 34. In this case, the dynamic module interface reference 18 included in the task block 10 may refer to (*Msg( )) the functions Msg( ) of the dynamic module interface 34 (i.e., *Msg( )→Msg( )).

### <Linking of Data S306>

After the symbols of the functions Msg( ) are linked, the dynamic module manager block 16 transmits a symbol of the dynamic module data. 20 to the dynamic module wrapper block 32. A this time the dynamic module wrapper block 32 links the dynamic module data 20 to the dynamic module data reference 36 (i.e., *Data→Data).

By passing through steps S300 to S306, the process of the software is set to a state in which it can receive an external message and perform a preset service function.

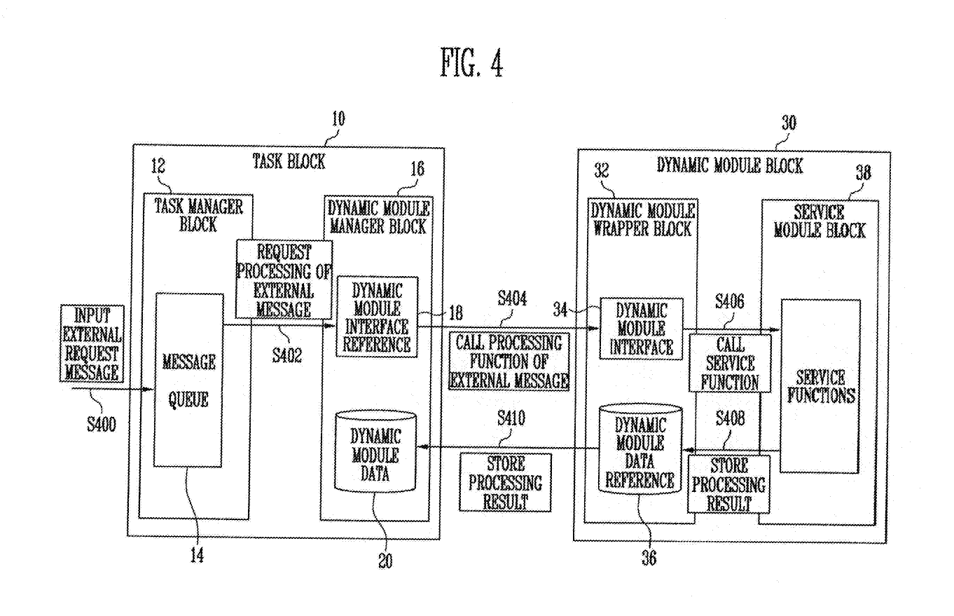

FIG. 4 is a diagram illustrating a message processing procedure of the process of the software according to an embodiment of the present disclosure.

The message processing procedure will be described as follows with reference to FIG. 4.

### <Inputting of External Request Message: S400>

First at least one request message corresponding to a specific operation is input from the outside. The at least one request message input from the outside is stored in the message queue 14 of the task manager block 12. The task manager block 12 controls the request messages stated in the message queue 14 to be sequentially processed.

### <Requesting of Processing: S402, S404>

The task manager block 12 requests the dynamic module interface reference 18 to call a processing function, corresponding to the request messages stored in the message queue 14. Here, the dynamic module interface reference 18 and the dynamic module interface 34 are symbolically linked with each other, and hence the request for calling the function in step S402 is immediately transmitted to the dynamic module interface 34.

### <Processing of Service: S406>

The function called from the dynamic module interface 34 calls a service function of the service module block 38. Then, the service module block 38 performs a service using the called service function.

### <Storing of Processing Result: S408, S410>

The service function included in the service module block 38 performs a service operation, and stores data corresponding to the performance result in the dynamic module data reference 36. Here, the dynamic module data reference 36 is symbolically linked with the dynamic module data 20, and hence the data corresponding to the performance result is automatically stored in the dynamic module data 20.

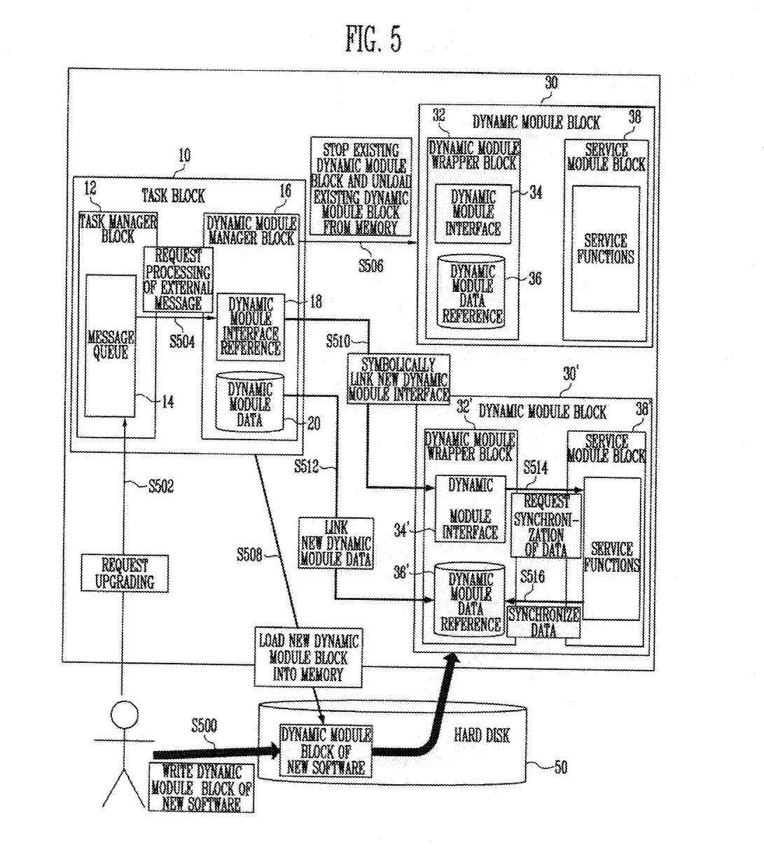

FIG. 5 is a diagram illustrating an upgrading method of the software.

The upgrading method will be described as follows with reference to FIG. 5.

### <Storing of Upgraded Software: S500>

First, a user writes (programs) a dynamic module block 30′ of new software such that a predetermined function is upgraded. After that, the user stores the dynamic module block 30 of the new software in a hard disk 50.

### <Requesting of Upgrading: S502>

After the new software is stored in the hard disk 50, the user transmits a message for requesting upgrading of the new software to a running process, i.e., the task block 10.

### <Requesting of Processing: S504>

The message for requesting the upgrading of the new software is stored in the message queue 14. After that, the task manager block 12 transmits the message to the dynamic module manager block 16.

### <Unloading of Existing Dynamic Module Block: S506>

The dynamic module manager block 16 receiving the message stops the operation of the existing dynamic module block 30 and unloads the existing dynamic module block 30 from the memory.

### <Loading of New Dynamic Module Block: S508>

After that the dynamic module manager block 16 loads, into the memory, the dynamic module block 30′ of the new software, which is stored in the hard disk 50.

### <Linking of New Dynamic Module Block: S510, S512>

After that, the dynamic module interface reference 18 is symbolically linked with a new dynamic module interface 34′. Similarly, the dynamic module data 20 is symbolically linked with a new dynamic module data reference 36′.

### <Synchronizing of Data: S514, S516>

After that the new dynamic module interface 34′ requests a service module block 38′ to synchronize the dynamic module data 20. Then, the service module block 38′ synchronizes the dynamic module data 20 with reference to the dynamic module data reference 36′, and performs a service using the synchronized dynamic module data 20. Then, the dynamic module data 20 is upgraded corresponding to the service of the ser ice module block 38′.

In the present disclosure, by passing through steps S500 to S516, the dynamic module block 30′ can be upgraded without stopping the task block 10. Further, in the present disclosure, the dynamic module data 20 for a service is stored in the task block 10. In this case, although the dynamic module block 30′ is upgraded, the service may be performed using the same dynamic module data 20. Accordingly, it is possible to ensure operational reliability.

As described above, in the present disclosure, a dynamic module in charge of a service can be upgraded without stopping software.

In the system including the software and the non-stop upgrading method of the running software according to the present disclosure, a process is driven by being divided into a task block and a dynamic module block. The dynamic module block is replaced when a program is upgraded, and data included in the task block is linked with the replaced dynamic module block, thereby upgrading the program without stopping any service.

Example embodiments have been disclosed herein, and although specific terms are employed, they are used and are to be interpreted in a generic and descriptive sense only and not for purpose of limitation. In some instances, as would be apparent to one of ordinary skill in the art as of the tiling of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A system including software, comprising:
a task block loaded into a memory, the task block being communicable with the outside through a message; and
a dynamic module block loaded into the memory, the dynamic module block being symbolically linked with the task block to provide a service corresponding to the message.

2. The system of claim 1, wherein the dynamic module block is replaceable without stopping the task block.

3. The system of claim 1, wherein the task block includes:
a task manager block including a message queue in which the message is stored; and
a dynamic module manager block including a dynamic module interface reference for calling a function corresponding to the message and dynamic module data modified and generated corresponding to the service of the dynamic module block.

4. The system of claim 3, wherein the dynamic module block includes:
a service module block including service functions to provide the service; and
a dynamic module wrapper block including a dynamic module interface having the service functions registered therein, the dynamic module interface being symbolically linked with the dynamic module interface reference, and a dynamic module data reference symbolically linked with the dynamic module data.

5. A non-stop upgrading method of software including a task block and a first dynamic module block, the non-stop upgrading method comprising:
storing, in a hard disk, a second dynamic module block for upgrading the first dynamic module block;
requesting the task block to upgrade the tint dynamic module block;
unloading, by the task block, the first dynamic module block from a memory;
loading, by the task block, the second dynamic module block into the memory; and
connecting the second dynamic module block to the task block.

6. The non-stop upgrading method of claim 5, wherein the connecting of the second dynamic module block includes:
symbolically linking a dynamic module interface to a dynamic module interface reference included in the task block, wherein the dynamic module interface is included in the second dynamic module block and has function registered therein; and
symbolically linking dynamic module data stored in the task block to a dynamic module data reference included in the second dynamic module block.

7. The non-stop upgrading method of claim 6, wherein the connecting of the second dynamic module block hither includes performing, by a service module block included in the second dynamic module block, a predetermined service using the dynamic module data.

8. The non-stop upgrading method of claim 7, wherein the dynamic module data is updated corresponding to the service of the service module block.
